(19) United States
(12) Patent Application Publication
(10) Pub. No.: US 2006/0050377 A1
(43) Pub. Date: Mar. 9, 2006

(54) Supporting device for a telescope during observation

(75) Inventors: Paul Kuo, Tainan (TW); Hsiung-Chin Chung, Tainan (TW)

Correspondence Address: BACON & THOMAS, PLLC, 625 SLATERS LANE, FOURTH FLOOR, ALEXANDRIA, VA, 22314, US

(73) Assignee: Sun Long Optics Co., Ltd., Tainan (TW)

(21) Appl. No.: 10/933,330

(22) Filed: Sep. 3, 2004

(51) Int. Cl. G02B 23/00

(52) U.S. Cl. 359/430; 359/399

(57) ABSTRACT

A supporting device for a telescope during observation includes a cylindrical housing of a reflexive telescope and an eye-viewing unit fixed on a side surface of the front end section of the cylindrical housing, a grip fixed on a lower surface of the front end section of the housing, and a shoulder stand fixed on a lower surface of a rear end section of the cylindrical housing. The height of the shoulder stand is adjustable. In using, the shoulder stand is placed on a shoulder, and a user holds the grip with one hand, with the height of the shoulder stand adjusted to permit the eye-viewing unit aligned to the level of an eye of the user. Thus the telescope can be stabilized for observing in spite of turning together with the body for tracing a moving object.

### BACKGROUND OF THE INVENTION

1. Field of the Invention

This invention relates to a supporting device for a telescope during observation, particularly to one considerably stabilizing a telescope on a shoulder during observing with the telescope, having excellent mobility for easy observation.

2. Description of the Prior Art

The larger the lens diameter of a telescope is, the clearer the image is to be seen through the telescope, with more light able to enter the telescope to make the image to be seen more clearer. So the weight of a telescope of a large size becomes so heavier that a user may feel it quite hard to support the telescope with hands during observing.

So conventional telescopes have the following disadvantages.

1. If the weight of a telescope is rather heavy, it is quiet difficult for a user to support it stably to cause frequent swaying of the telescope, and a position frame may be used for a large telescope, causing inconvenience for moving it.

2. Provided that a moving object (for example, birds) to be observed with a large telescope supported on a position frame, the position frame has to be moved at the same time with the telescope, often causing disappointments for a user to lose track of the object.

### SUJMMARY OF THE INVENTION

This invention has been devised to offer a supporting device for a telescope during observation able to rest on a shoulder and easily movable together with the body of a user to keep track of a moving object with ease.

The feature of the invention is a cylindrical housing of a reflexive telescope, which is provided with a grip fixed under a front end portion of the housing, and a shoulder stand fixed under a rear end of the housing and adjustable in its height by rotating a female-threaded tube fixed on a convex plate resting on a shoulder and engaging a male-threaded rod of the shoulder stand. Then in using, a user holds the grip with one hand and the shoulder stand is placed on a shoulder of the user, and the telescope is kept considerably stable with excellent mobility together with the body turning for tracing a moving object in observing.

### BRIEF DESCRIPTION OF DRAWINGS

This invention will be better understood by referring to the accompanying drawings, wherein:

FIG. 1 is a perspective view of a supporting device for a telescope during observation in the present invention;

FIG. 2 is an exploded perspective view of the supporting device for a telescope during observation in the present invention;

FIG. 3 is a side view of the supporting device for a telescope during observation in the present invention;

FIG. 4 is a cross-sectional view of the line B-B in FIG. 3;

FIG. 5 is a cross-sectional view of the line A-A in FIG. 3;

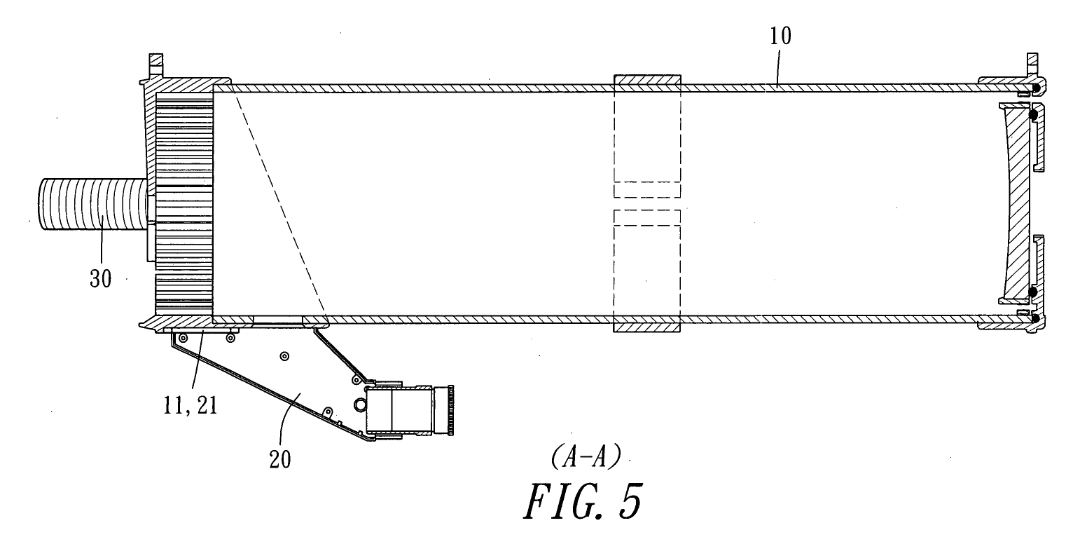

FIG. 6 is a cross-sectional view of the line C-C in FIG. 3;

FIG. 7 is a side cross-sectional view of the supporting device for a telescope during observation being adjusted in its height in the present invention; and,

FIG. 8 is a side view of the supporting device for a telescope during observation placed on a shoulder for use.

### DETAILED DESCRIPTION OF THE PREFERRED EMBODIMENT

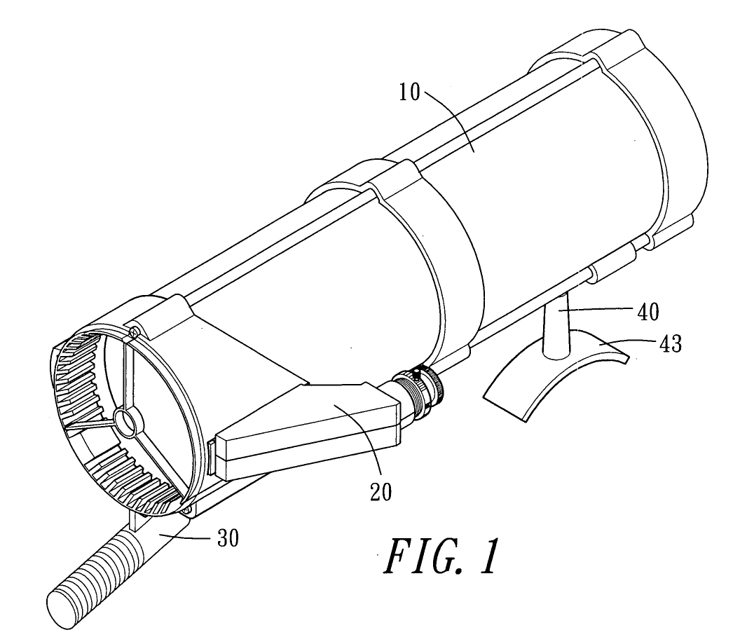

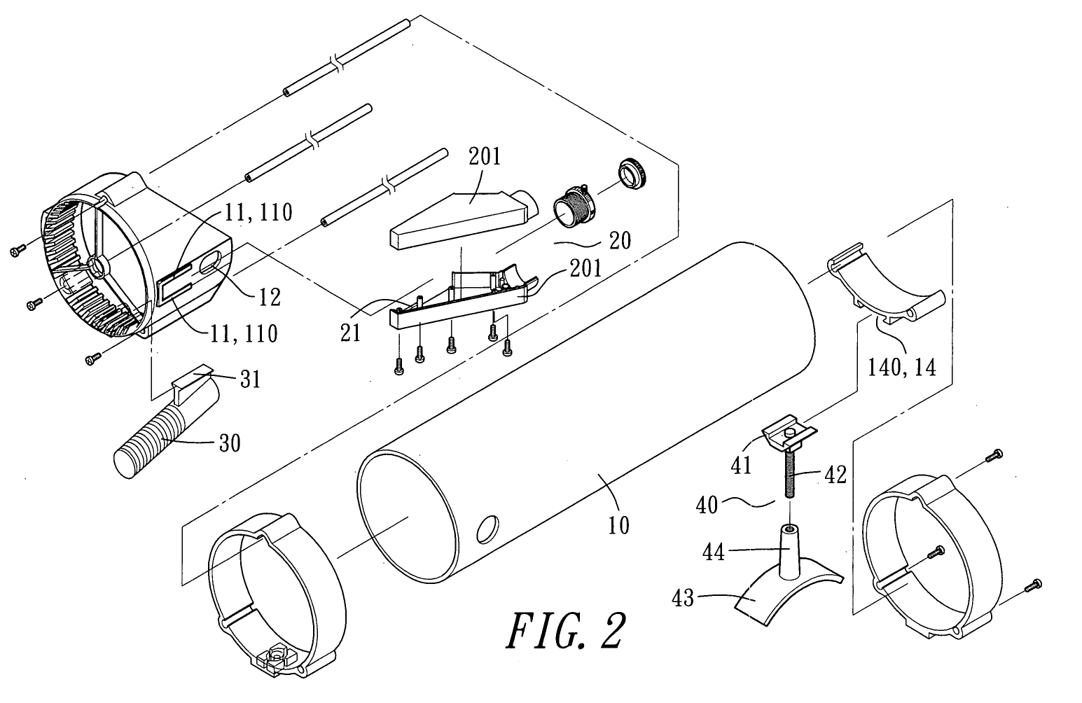

A preferred embodiment of a supporting device for a telescope during observation in the present invention, as shown in FIGS. 1 and 2, includes a cylindrical housing 10 of a reflexive telescope, and an eye-viewing unit 20 fixed on a side surface of a front end section of the cylindrical housing 10, a grip 30 fixed on a lower surface of the front end section of the cylindrical housing 10, and a shoulder stand 40 fixed on a lower surface of a rear end section of the cylindrical housing 10 as main components.

The cylindrical housing 10 has a reflexive lens in its interior for reflecting an image of an object at a front distance to the eye-viewing unit, through which a user can see the image. And the structure combining the cylindrical housing 10 and the eye-viewing device 20 includes two lateral grooves 11 formed in the front end section of the cylindrical housing 10 and an insert hole 110 near the two lateral grooves 11, and two insert bars 21 formed in an upper and a lower shell 201 of the eye-viewing unit 20 to insert in the insert hole 110 through the two lateral grooves 11. Then the upper and the lower shell 201 are tightly combined together with screws, and also fixed the eye-viewing unit 20 in the side wall of the front end section of the cylindrical housing 10. The cylindrical housing 10 further has a hole 12 as that formed in a conventional telescope for the image reflected to reach in the eye-viewing unit 20 through the hole 12.

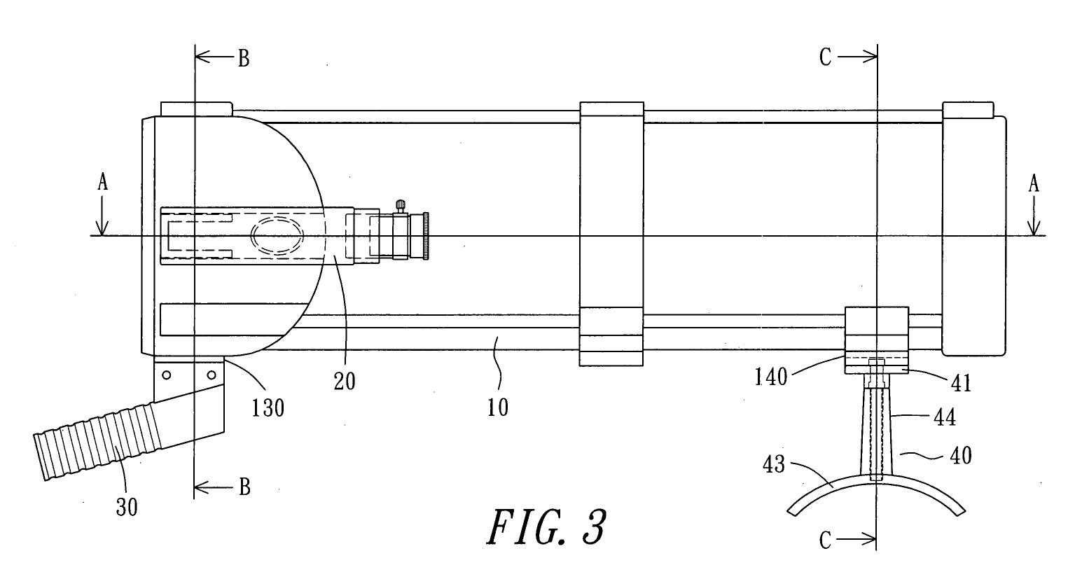

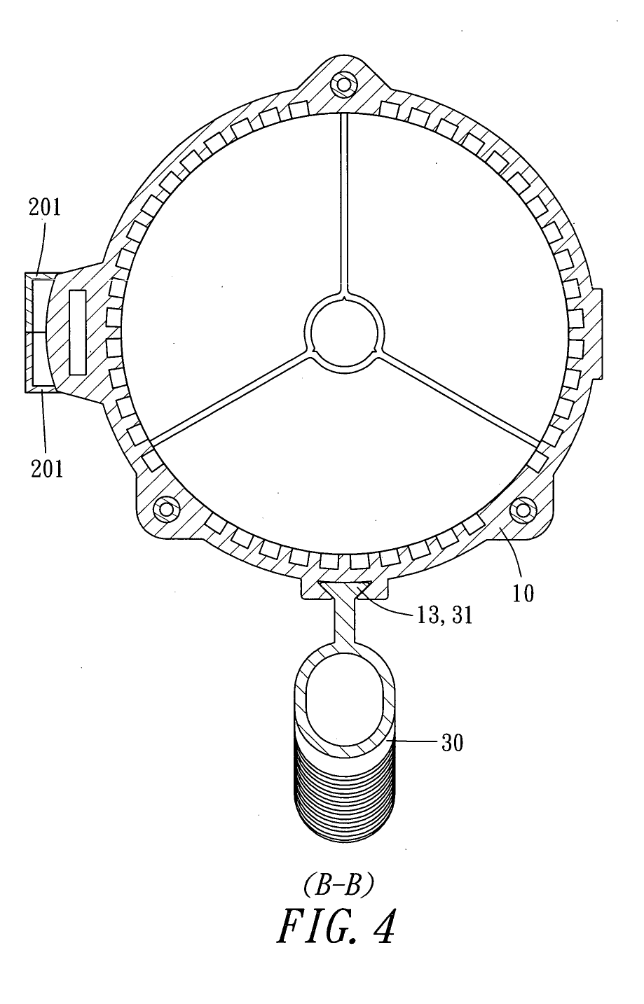

The grip 30 is to be gripped by a hand of a user for using the telescope, as shown in FIGS. 2 and 4, fixed on a lower surface of the front end section of the cylindrical housing 10, with a first dovetail-shaped groove 13 formed in the lower surface of the front end section of the cylindrical housing 10. The first dovetail shaped groove 13 is laterally positioned, and an insert hole 130 formed in the front end section faces toward the rear end of the cylindrical housing 10 as shown in FIG. 3, with the front end of the first dovetail-shaped groove 13 is closed by the front end of the cylindrical housing 10. The grip 30 has a dovetail-shaped combine block 31 on its upper end as shown in FIG. 4, inserting through the insert hole 130 and then fitting in the dovetail-shaped groove 13 stably. The front end of the grip 30 extends sloping down towards under the front of the cylindrical housing 10 for a hand of a user to grip easily. Moreover, the grip 30 can be made hollow to contain various lenses of large, medium and small magnification for changing them for proper observation if needed to.

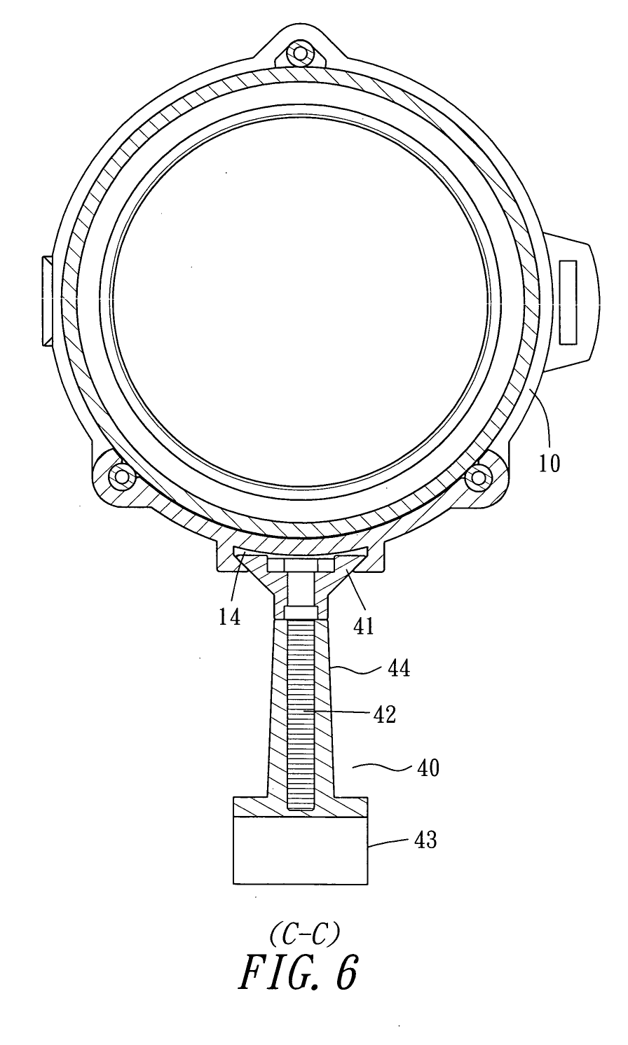

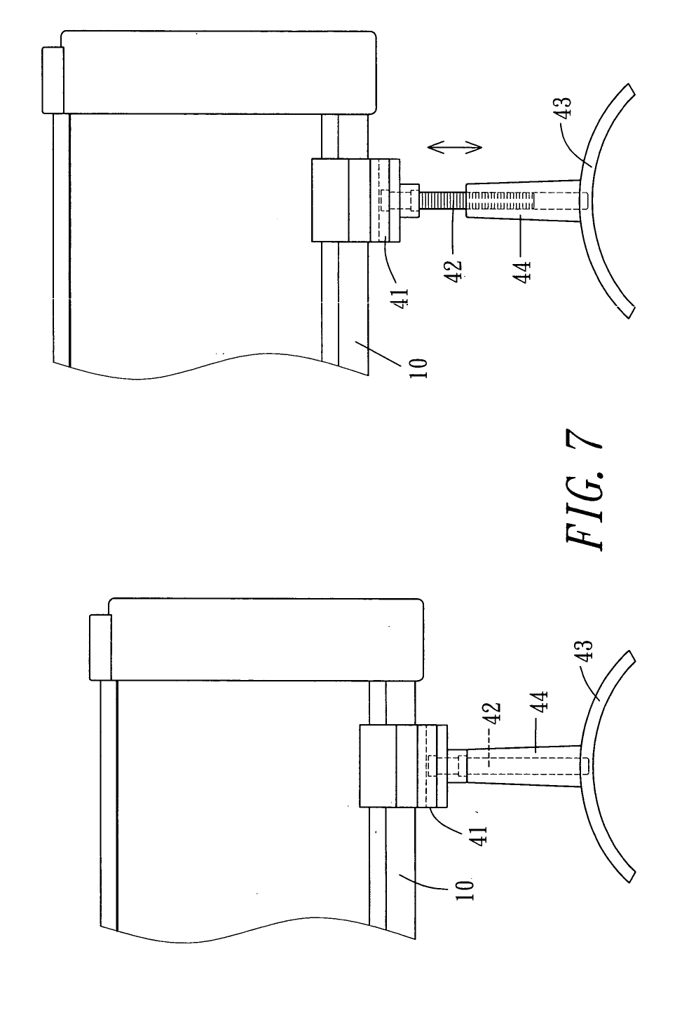

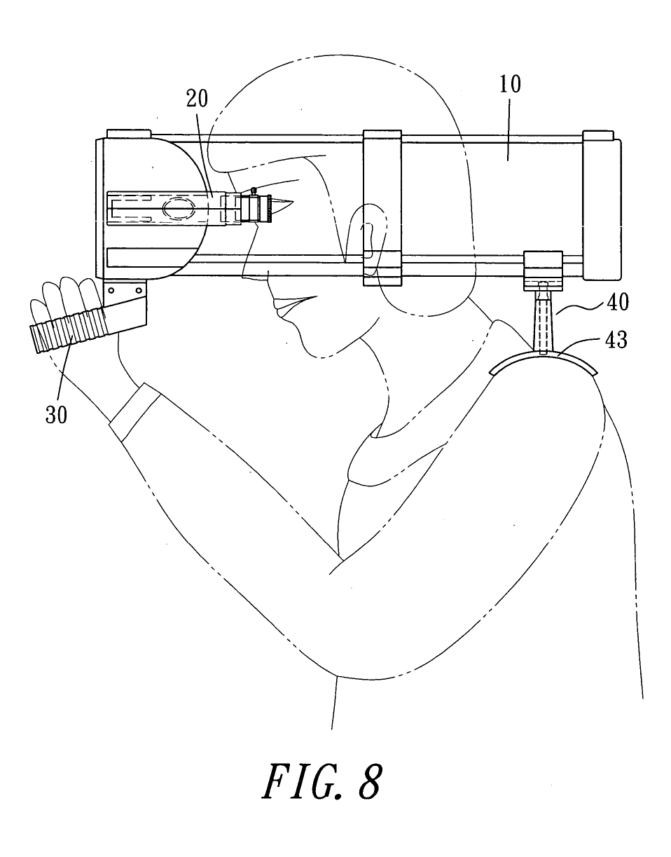

The shoulder stand 40 as shown in FIGS. 2 and 6, is fixed on the lower surface of a rear end section of the cylindrical housing 10 formed with a second dovetail-shaped groove 14 with an insert mouth 140 facing to the front end of the housing 10 and closed at the rear end. The shoulder stand 40 has a dovetail-shaped combine block 41 formed on the upper end as shown in FIGS. 2 and 6 to fit through the insert mouth 140 and then into the insert groove 14 stably, and a male-threaded rod 42 extending down from the combine block 41, and a convex plate 43 with an upright female-threaded tube 44 on the center of the plate 43 for engaging with the threaded rod 42 so as to adjust the distance between the plate 43 and the cylindrical housing 10, as shown in FIG. 7. Thus the plate 43 can be placed on a shoulder of a user, with the grip 30 tightly held in a hand of the user for supporting a telescope as shown in FIG. 8, with the threaded tube 44 of the plate 43 rotated and adjusted nearer to or further from the cylindrical housing 10 so as to let the eye-viewing unit 20 just aligned to the level of an eye of the user.

In using, the convex plate 43 is placed on a shoulder of a user, and a hand of the user catches the grip 30, supporting the front end and the rear end of a telescope. As the shape of the convex plate 43 suits the shape of the shoulder of a person, it can support the telescope easily to permit the telescope to move together with the body moved to trace accurately an object in motion. Further, the height of the distance between convex plate 43 and the cylindrical housing 10 can be adjusted by rotating the threaded tubes 44 to let the eye-viewing unit 20 aligned properly to the level of the eye of the user. Therefore, the supporting device for the telescope during observation has superb mobility and stability because of the fitting mode and the accurate orientation by the dovetail shape of the components for inseparable combination of the grip 30 and the shoulder stand 40 with the cylindrical housing 10 during using process.

While the preferred embodiment of the invention has been described above, it will be recognized and understood that various modifications may be made therein and the appended claims are intended to cover all such modifications that may fall within the spirit and scope of the invention.

What is claimed is:

1. A supporting device for a telescope during observation comprising a cylindrical housing of a reflexive telescope, an eye-viewing unit fixed on a side surface of a front end section of said cylindrical housing, a grip fixed firmly on a lower surface of the front end section of said cylindrical housing and extending forward sloping down, a shoulder stand fixed on a lower surface of a rear end section of said cylindrical housing and extending upright down, said shoulder stand having a convex plate in its lower end, said convex plate possible to suit to rest on a shoulder of a user, the distance of the convex plate and said cylindrical housing possible to be adjusted.

2. The supporting device for a telescope as claimed in claim 1, wherein said grip and said shoulder stand are combined together respectively with said cylindrical housing by means of mutual engagement of a dovetail-shaped groove formed in a lower side of said cylindrical housing and a dovetail-shaped block formed on an upper end of said grip and said shoulder stand.

3. The supporting device for a telescope during observation as claimed in claim 1, wherein said eye-viewing unit and said cylindrical housing are combined together by means of engagement of two lateral grooves and an insert hole beside the two grooves formed on the side wall of said cylindrical housing and two insert bars formed in an upper and a lower shell of said eye-viewing unit and also by means of screws screwing together said upper and said lower shell of said eye-viewing unit.

4. The supporting device for a telescope during observation as claimed in claim 1, wherein said grip has its front end extending sloping down toward the front end of said cylindrical housing for easily gripped by a hand of a user.

5. The supporting device for a telescope during observation as claimed in claim 1, wherein said convex plate extends to the front and to the rear, with the center portion curved up.

6. The supporting device for a telescope during observation as claimed in claim 1, wherein said convex plate of said shoulder stand has a male-threaded rod extending upright down, a female threaded tube is provided firmly to stand on the center of said convex plate for said male-threaded rod to engage with so that the distance between the convex plate and the cylindrical housing may be adjusted by engaging the male-threaded rod deeply or shallowly so as to permit said eye-viewing unit aligned to the level of an eye of a user.
